(19) United States
(12) Patent Application Publication
(10) Pub. No.: US 2024/0028914 A1
(43) Pub. Date: Jan. 25, 2024

(54) METHOD AND SYSTEM FOR MAINTAINING A DATA EXTRACTION MODEL

(71) Applicant: Dell Products L.P., Round Rock, TX (US)

(72) Inventors: Saurabh Jha, Bangalore (IN); Adya Jha, Dhanbad (IN); Guhesh Swaminathan, Chennai (IN)

(21) Appl. No.: 17/871,553

(22) Filed: Jul. 22, 2022

(51) Int. Cl. G06N 5/02; G06N 20/00

(52) U.S. Cl. CPC G06N 5/022; G06N 20/00

(57) ABSTRACT

Techniques described herein relate to a method for performing data extraction for documents. The method includes obtaining a data extraction request associated with a document; in response to obtaining the request: generating a data extraction prediction using a prediction model and the document; providing the data extraction prediction to a user; obtaining a user validation associated with the data extraction prediction; making a determination that the user validation indicates that the data extraction prediction is not correct; in response to the determination: generating an updated data extraction prediction based on the user validation; and initiating performance of additional document processing using the document based on the updated data extraction prediction.

### BACKGROUND

Computing devices may provide services. To provide the services, the computing devices may require data included in documents. To obtain the data from the documents, the computing devices may extract the data from the documents. The documents may include multiple types of documents. Each type of document may include different types of data.

### SUMMARY

In general, certain embodiments described herein relate to a method for performing data extraction for documents. The method may include obtaining a data extraction request associated with a document; in response to obtaining the request: generating a data extraction prediction using a prediction model and the document; providing the data extraction prediction to a user; obtaining a user validation associated with the data extraction prediction; making a determination that the user validation indicates that the data extraction prediction is not correct; in response to the determination: generating an updated data extraction prediction based on the user validation; and initiating performance of additional document processing using the document based on the updated data extraction prediction.

In general, certain embodiments described herein relate to a system for performing state management services for composed information handling systems. The system includes a plurality of clients and a document preprocessing engine that is configured to obtain a data extraction request associated with a document; in response to obtaining the request: generate a data extraction prediction using a prediction model and the document; provide the data extraction prediction to a user; obtain a user validation associated with the data extraction prediction; make a determination that the user validation indicates that the data extraction prediction is not correct; in response to the determination: generate an updated data extraction prediction based on the user validation; and initiate performance of additional document processing using the document based on the updated data extraction prediction.

In general, certain embodiments described herein relate to a non-transitory computer readable medium that includes computer readable program code, which when executed by a computer processor enables the computer processor to perform a method for performing data extraction for documents. The method may include obtaining a data extraction request associated with a document; in response to obtaining the request: generating a data extraction prediction using a prediction model and the document; providing the data extraction prediction to a user; obtaining a user validation associated with the data extraction prediction; making a determination that the user validation indicates that the data extraction prediction is not correct; in response to the determination: generating an updated data extraction prediction based on the user validation; and initiating performance of additional document processing using the document based on the updated data extraction prediction.

Other aspects of the embodiments disclosed herein will be apparent from the following description and the appended claims.

### BRIEF DESCRIPTION OF DRAWINGS

Certain embodiments disclosed herein will be described with reference to the accompanying drawings. However, the accompanying drawings illustrate only certain aspects or implementations of the embodiments disclosed herein by way of example and are not meant to limit the scope of the claims.

FIG. 1 shows a diagram of a system in accordance with one or more embodiments disclosed herein.

FIGS. 2A-2B show flowcharts of methods in accordance with one or more embodiments disclosed herein.

FIGS. 3A-3B show a diagrams of examples in accordance with one or more embodiments disclosed herein.

FIG. 4 shows a diagram of a computing device in accordance with one or more embodiments disclosed herein.

### DETAILED DESCRIPTION

Specific embodiments will now be described with reference to the accompanying figures. In the following description, numerous details are set forth as examples of the embodiments disclosed herein. It will be understood by those skilled in the art that one or more embodiments disclosed herein may be practiced without these specific details and that numerous variations or modifications may be possible without departing from the scope of the embodiments disclosed herein. Certain details known to those of ordinary skill in the art are omitted to avoid obscuring the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this Detailed Description, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

In general, embodiments disclosed herein relate to systems, non-transitory computer readable mediums, and methods for performing data extraction services for documents.

In one or more embodiments, traditional document data extraction systems may include manual data extraction performed by human users of the systems. Such manual data extraction may require a significant amount of users' time to handle large quantities of documents. Additionally, manual data extraction may be susceptible to human errors. As data extraction systems have advanced, traditional data extraction prediction models have been employed to generate data extraction predictions. However, the accuracy of traditional data extraction prediction models may suffer when handling documents with varying types of data and varying document layouts.

To address, at least in part, the aforementioned data extraction issues, embodiments disclosed herein provide document data extraction prediction services with automatic user validation. Specifically, a system in accordance with embodiments disclosed herein may generate data extraction predictions for documents using a prediction model. A user interface may be generated to enable a user to efficiently submit user validations that indicate whether the data extraction predictions are correct. If the data extraction predictions are incorrect, the user may submit correction information specifying the correct portion of the data included in the document associated with the data extraction prediction that may be used to correct the data extraction prediction. The user validation may also be used in combination with copies of documents and corresponding data extraction predictions to generate and store training documents. The training documents may be used to generate updated prediction models to address variances in document content and layout. As a result, efficiency and accuracy of data extraction services may be improved.

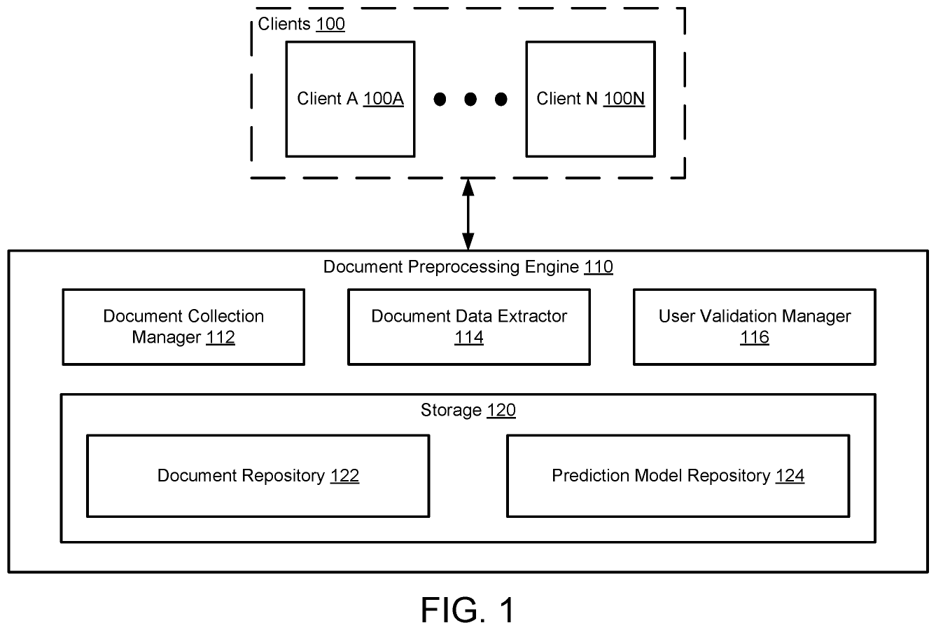

FIG. 1 shows a diagram of a system in accordance with one or more embodiments disclosed herein. The system may include clients (100) that obtain document preprocessing services from a document preprocessing engine (110). The upgrade failure prediction services may include automatically generating, using a prediction model, data extraction predictions for documents obtained from the clients (100) that indicate the type of data extracted from the document and specify the data extracted from the document prior to performing additional analysis and/or actions using the document. The document preprocessing services may further include obtaining user validations associated with the data extraction predictions, and using the user validations, the documents, and the data extraction predictions to generate training documents that may be used to update the prediction model. By utilizing such services, data may be efficiently and accurately extracted from documents prior to advances down data pipeline while automatically generating training documents to update the prediction model to maintain prediction accuracy.

The components of the system illustrated in FIG. 1 may be operably connected to each other and/or operably connected to other entities (not shown) via any combination of wired and/or wireless networks. Each component of the system illustrated in FIG. 1 is discussed below.

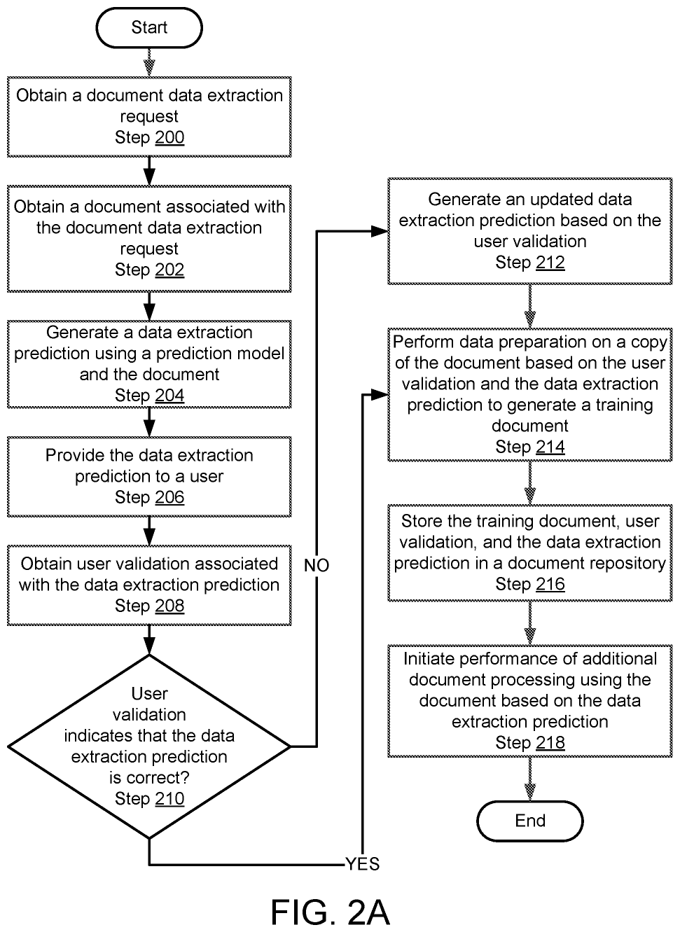

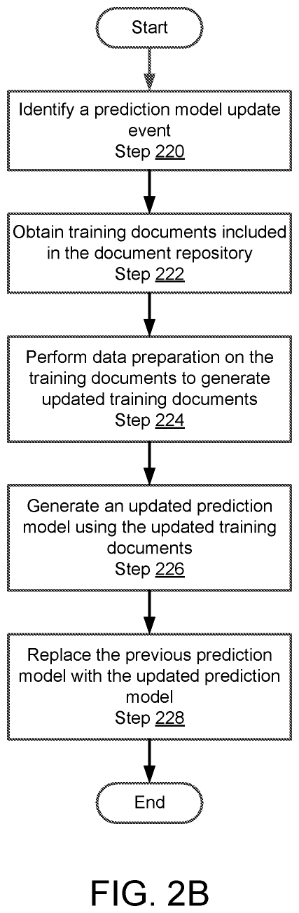

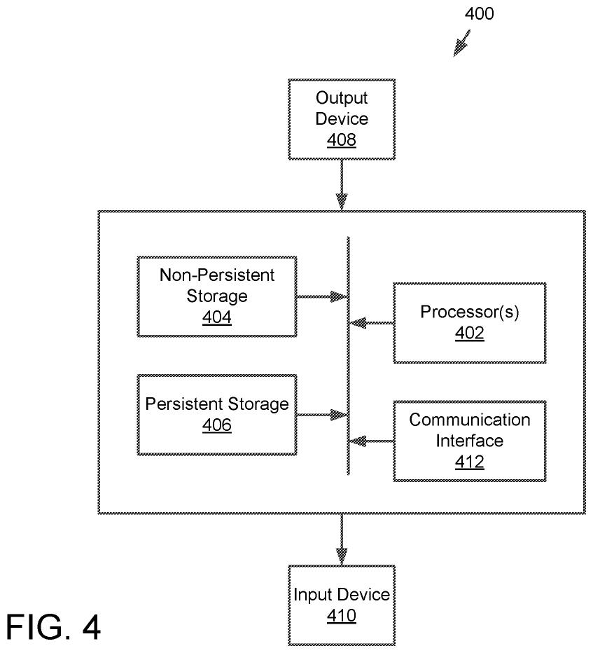

The clients (100) may be implemented using computing devices. The computing devices may be, for example, mobile phones, tablet computers, laptop computers, desktop computers, servers, or cloud resources. The computing devices may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions described herein and/or all, or a portion, of the methods illustrated in FIGS. 2A-2B. The clients (100) may be implemented using other types of computing devices without departing from the embodiments disclosed herein. For additional details regarding computing devices, refer to FIG. 4.

The clients (100) may be implemented using logical devices without departing from embodiments disclosed herein. For example, the clients (100) may include virtual machines that utilize computing resources of any number of physical computing devices to provide the functionality of the clients (100). The clients (100) may be implemented using other types of logical devices without departing from the embodiments disclosed herein.

In one or more embodiments, the clients (100) include the functionality to and/or are otherwise configured to perform computer implemented services. The computer implemented services may include, for example, purchase order processing, inventory management, accounting services, etc. The computer implemented services may include using information obtained from documents such as purchase orders, inventory lists, accounting forms, etc. Therefore, the clients (100) may include the functionality to provide the documents to the document preprocessing engine (110) for data extraction services prior to performing the computer implemented services using the documents. Otherwise, users of the clients (100) may be required to manually perform data extraction which, with large quantities of documents, may require a lot of manual time and labor.

In one or more embodiments, as discussed above, the clients (100) may utilize data extraction prediction services provided by the document preprocessing engine (110). Using the data extraction prediction services may enable the clients (100) to avoid inefficient use of computing and/or manual resources to data extraction of documents required by the clients (100) to perform the computer implemented services.

To use the data extraction prediction services, the clients (100) may perform actions under the directions of the document preprocessing engine (110). By doing so, the document preprocessing engine (110) may orchestrate the transmission of data (e.g., documents, data extraction predictions, etc.) and/or actions between the document preprocessing engine (110) and the clients (100).

For example, a client (100) may send documents to the document preprocessing engine (110). The document preprocessing engine (110) may generate prediction models that may generate data extraction predictions that specify the data extracted from the documents of a client (100) (or other third party entity not illustrated in the system of FIG. 1).

The document preprocessing engine (110) may provide the documents and associated data extraction predictions (e.g., using a user interface, discussed below) to a user of a client (e.g., 100A) or other entities (e.g., the document preprocessing engine (110), a third party entity not illustrated in the system of FIG. 1, etc.) for user validation. The user of a client (e.g., 100A) may provide user validations specifying whether the data extraction predictions are correct or incorrect to the document preprocessing engine (110). The document preprocessing engine (110) may provide the correct data extraction predictions and the associated documents to the clients (100) for further processing.

A system in accordance with one or more embodiments disclosed herein may include any number of clients (e.g., 100A, 100N) without departing from the embodiments disclosed herein. For example, a system may include a single client (e.g., client A (100A)) or multiple clients (e.g., client A (100A) and client N (100N)).

In one or more embodiments, the document preprocessing engine (110) may be implemented using one or more computing devices. A computing device may be, for example, a mobile phone, tablet computer, laptop computer, desktop computer, server, distributed computing system, or a cloud resource. The computing device may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions of the document preprocessing engine (110) described herein and/or all, or a portion, of the methods illustrated in FIGS. 2A-2B. The document preprocessing engine (110) may be implemented using other types of computing devices without departing from the embodiments disclosed herein. For additional details regarding computing devices, refer to FIG. 4.

The document preprocessing engine (110) may be implemented using logical devices without departing from the embodiments disclosed herein. For example, the document preprocessing engine (110) may include virtual machines that utilize computing resources of any number of physical computing devices to provide the functionality of the document preprocessing engine (110). The document preprocessing engine (110) may be implemented using other types of logical devices without departing from the embodiments disclosed herein.

In one or more embodiments, the document preprocessing engine (110) may include the functionality to or otherwise be configured to provide data extraction prediction services. Data extraction prediction services may include (i) generation of prediction models (146), (ii) generation of predictions for data extracted from documents of the clients (100), and/or (iii) obtaining user validations associated with data extraction predictions. By doing so, the document preprocessing engine (110) may improve the efficiency and accuracy of performing data extraction services on documents required by clients (100) for further processing. The document preprocessing engine (110) may include the functionality to perform other and/or additional services without departing from embodiments disclosed herein. For additional information regarding the functionality of the document preprocessing engine (110), refer to FIGS. 2A-2B.

To perform the data extraction prediction services, the document preprocessing engine may include a document collection manager (112), a document data extractor (114), a user validation manager (116), and a storage (120). The document preprocessing engine (110) may include other, additional, and/or fewer components without departing from embodiments disclosed herein. Each of the aforementioned components of the document preprocessing engine (110) is discussed below.

In one or more embodiments disclosed herein, the document collection manager (112) is implemented as physical device. The physical device may include circuitry. The physical device may be, for example, a field-programmable gate array, application specific integrated circuit, programmable processor, microcontroller, digital signal processor, or other hardware processor. The physical device may be configured to provide the functionality of the document collection manager (112) described throughout this Detailed Description.

In one or more embodiments disclosed herein, the document collection manager (112) is implemented as computer instructions, e.g., computer code, stored on a persistent storage that when executed by a processor of the document preprocessing engine (110) causes the document preprocessing engine (110) to provide the functionality of the document collection manager (112) described throughout this Detailed Description.

In one or more embodiments, the document collection manager (112) includes the functionality to or is otherwise configured to obtain and manage documents. The document collection manager (112) may request and/or obtain documents that require data extraction prediction services from the clients (100) or other entities not illustrated in the system of FIG. 1. The document collection manager (112) may include the functionality to store the documents in the storage (120) (e.g., in the document repository (122), discussed below). The document collection manager (112) may further include the functionality to store training documents generated during the performance of data extraction prediction services in the storage (120) (e.g., in the document repository (122), discussed below). The document collection manager (112) may include the functionality to perform all, or a portion thereof, the steps in the methods depicted in FIGS. 2A-2B. The document collection manager (112) may include or be configured to perform other and/or additional functionalities without departing from embodiments disclosed herein. For additional information regarding the functionality of the document collection manager (112), refer to FIGS. 2A-2B.

In one or more embodiments disclosed herein, the document data extractor (114) is implemented as physical device. The physical device may include circuity. The physical device may be, for example, a field-programmable gate array, application specific integrated circuit, programmable processor, microcontroller, digital signal processor, or other hardware processor. The physical device may be configured to provide the functionality of the document data extractor (114) described throughout this Detailed Description.

In one or more embodiments disclosed herein, the document data extractor (114) is implemented as computer instructions, e.g., computer code, stored on a persistent storage that when executed by a processor of the document preprocessing engine (110) causes the document preprocessing engine (110) to provide the functionality of the document data extractor (114) described throughout this Detailed Description.

In one or more embodiments, the document data extractor (114) includes the functionality to or is otherwise configured to generate prediction models and generate data extraction predictions for documents using the prediction models. The document data extractor (114) may generate prediction models using training documents. The document data extractor (114) may include the functionality to generate training documents using user validations. The document data extractor (114) may further include the functionality to generate updated data extraction predictions based on user validations. The document data extractor (114) may include the functionality to perform all, or a portion thereof, the steps in the methods depicted in FIGS. 2A-2B. The document data extractor (114) may include or be configured to perform other and/or additional functionalities without departing from embodiments disclosed herein. For additional information regarding the functionality of the document data extractor (114), refer to FIGS. 2A-2B.

In one or more embodiments disclosed herein, the user validation manager (116) is implemented as physical device. The physical device may include circuity. The physical device may be, for example, a field-programmable gate array, application specific integrated circuit, programmable processor, microcontroller, digital signal processor, or other hardware processor. The physical device may be configured to provide the functionality of the user validation manager (116) described throughout this Detailed Description.

In one or more embodiments disclosed herein, the user validation manager (116) is implemented as computer instructions, e.g., computer code, stored on a persistent storage that when executed by a processor of the document preprocessing engine (110) causes the document preprocessing engine (110) to provide the functionality of the user validation manager (116) described throughout this Detailed Description.

In one or more embodiments, the user validation manager (116) includes the functionality to or is otherwise configured to provide the data extraction prediction and the document to a user, and to obtain a user validation from the. The user validation manager (116) may generate a user interface that may provide a visual representation of the document and the data extraction prediction. The user may submit the user validation through the user interface. For additional information regarding the user interface, refer to FIG. 2A. The user validation manager (116) may provide the user validations to the document data extractor (114) for the generation of training documents and corrected data extraction predictions. User validation manager (116) may include the functionality to perform all, or a portion thereof, the steps in the methods depicted in FIGS. 2A-2B. The user validation manager (116) may include or be configured to perform other and/or additional functionalities without departing from embodiments disclosed herein. For additional information regarding the functionality of the user validation manager (116), refer to FIGS. 2A-2B.

In one or more embodiments, the storage (120) may be implemented using one or more volatile or non-volatile storages or any combination thereof. The storage (120) may include the functionality to, or otherwise be configured to, store information that may be used by the data preprocessing engine (110) and the components thereof (e.g., 112, 114, 116) to perform data extraction prediction services for documents of clients (100). The information stored in the storage (120) may include a document repository (122) and a prediction model repository (124). The storage (120) may store other and/or additional information without departing from embodiments disclosed herein. Each of the aforementioned types of information stored in the storage (120) is discussed below.

In one or more embodiments, the document repository (122) may include one or more data structures that include documents. The documents may include documents obtained and stored to be used by the document preprocessing engine (110) for data extraction prediction services. The documents may include any quantity of documents to be used by the document processing engine (110) for data extraction services without departing from embodiments disclosed herein. The documents may include, for example, purchase orders, inventory forms, job applications, accounting sheets, etc. The documents may include any type of documents that require data extraction for further processing by the clients (100) without departing from embodiments disclosed herein. The document repository (122) may also include document metadata. The document metadata may include information associated with the documents. The information associated with the documents may include a document identifier, a document type, a client identifier associated with a corresponding client (e.g., 100A) that provided the document and/or that may use the document for further processing, etc. The document metadata may include other and/or additional information associated with the documents without departing from embodiments disclosed herein.

In one or more embodiments, the document repository (122) may also include training documents generated through the performance of the data extraction prediction services. The training documents may include copies of original documents that include user validations, data extraction predictions, a creation timestamp, and document metadata associated with the original documents. The training documents may be used by the document data extractor (114) to generate updated prediction models.

In one or more embodiments, the document collection manager (112) may include the functionality to maintain the document repository (122). As discussed above, the document collection manager (112) may request and obtain documents from clients or other entities and store the documents in the document repository (122). The document collection manager (112) may obtain training documents from the document data extractor (114) and store the training documents in the document repository (122). The document collection manager (112) may provide documents and training documents from the document repository (122) to the document data extractor for data extraction prediction generation and prediction model generation. The document collection manager (112) may perform other and/or additional maintenance actions (e.g., removing documents, copying documents, providing documents to clients (100), etc.) associated with the document repository (122) without departing from embodiments disclosed herein.

In one or more embodiments, the prediction model repository (124) may include one or more prediction models. The prediction models may be data structures that represent any number of data extraction prediction models for generating data extraction predictions. The prediction models may be applied to documents to generate data extraction prediction specifying the type of data included in a document, the specific data of the data type, and/or a location within the document associated with the data. The prediction models may be, for example, a deep learning model generated by applying training documents to a deep learning algorithm. The deep learning algorithm may be any type of deep learning algorithm for generating deep learning models (e.g., deep neural networks, deep reinforcement learning networks, convolutional neural networks, etc.) without departing from embodiments disclosed herein.

While the data structures (e.g., 122, 124) are illustrated as separate data structures and have been discussed as including a limited amount of specific information, any of the aforementioned data structures may be divided into any number of data structures, combined with any number of other data structures, and may include additional, less, and/or different information without departing from embodiments disclosed herein. Additionally, while illustrated as being stored in the storage (120), any of the aforementioned data structures may be stored in different locations (e.g., in storage of other computing devices) and/or spanned across any number of computing devices without departing from embodiments disclosed herein.

Although the system of FIG. 1 is shown as having a certain number of components (e.g., 100A, 100B, 110, 112, 114, 116, 120, 122, 124), in other embodiments disclosed herein, the system may have more or fewer components. For example, the functionality of each component described above may be split across components or combined into a single component (e.g., the functionalities of the document collection manager (112), the document data extractor, and the user validation manager (116) may be combined to be implanted by a single component). Further still, each component may be utilized multiple times to carry out an iterative operation.

FIGS. 2A-2B show flowcharts in accordance with one or more embodiments. Turning now to FIG. 2A, FIG. 2A shows a flowchart of a method performed to generate data extraction predictions for documents in accordance with one or more embodiments disclosed herein. The method shown in FIG. 2A may be performed, for example, by a combination of the document collection manager (e.g., 112 FIG. 1), the document data extractor (e.g., 114, FIG. 1), and the user validation manager (e.g., 116, FIG. 1). Other components of the system in FIG. 1 may perform all, or a portion, of the method of FIG. 2A without departing from the scope of the embodiments described herein.

While FIG. 2A is illustrated as a series of steps, any of the steps may be omitted, performed in a different order, additional steps may be included, and/or any or all of the steps may be performed in a parallel and/or partially overlapping manner without departing from the scope of the embodiments described herein.

Initially, in Step 200, a document data extraction request is obtained. In one or more embodiments, the document collection manager of the document preprocessing engine may obtain a message from a client. A user of the client may generate the message to send to the document collection manager. The message may include a request to generate a data extraction prediction. The message may include the client identifier that may specify the client associated with the message. The message may include the document identifier associated with the document data extraction request. The message may also include contact information (e.g., network address, IP address, host address, digital signatures, public key infrastructure information, etc.) associated with a third party entity that includes the document associated with the document data extraction request. The document data extraction request may be obtained via other and/or additional methods without departing from embodiments disclosed herein.

In Step 202, a document associated with the document data extraction request is obtained. In one or more embodiments, the document collection manager of the document preprocessing engine uses the document identifier and the client identifier included in the document data extraction request to obtain the document associated with the document data extraction request. The document collection manager may first use the document identifier to check if the corresponding document is already stored in the document repository. If the document associated with the document identifier is stored in the document repository, then the document collection manager may retrieve the document from the document repository. In one or more embodiments, if the document associated with the document identifier is not included in the document repository, then the document collection manager may send a message that includes the document identifier and a request for the document to the client associated with the client identifier. In response to obtaining the request, the client may retrieve the document and send the document to the document collection manager.

In one or more embodiments, for document data extraction requests that include contact information associated with third party entities that include the document associated with the document data extraction request, the document collection manager may use the contact information to send a message to the third party entity. The contact information may enable the document collection manager to contact and/or otherwise communicate requests and/or data with the third party entity. The message may include a request for the document and the document identifier. In response to obtaining the request, the third party entity may retrieve the document and send the document to the document collection manager. The document associated with the document data extraction request may be obtained via other and/or additional methods without departing from embodiments disclosed herein.

In Step 204, a data extraction prediction is generated using a prediction model and the document. In one or more embodiments, the document collection manager may provide the document to the document data extractor of the document preprocessing engine. The document data extractor may introduce the document into the most recently generated prediction model. In other words, the most recently generated prediction model may use the document as an input and produce a data extraction prediction associated with the document. The data extraction prediction may include a portion of data included in the document and that is associated with a data type. For example, for a purchase order, the data extraction prediction may include a portion of the text of the document corresponding to a customer identifier. In one or more embodiments, the most recently generated prediction model may generate multiple data extraction predictions for the document. Continuing with the purchase order example, the data extraction predictions may include: (i) a predicted first portion of the data included in the document corresponding to the customer identifier, (ii) a predicted second portion of the data included in the document corresponding to a customer address, (iii) a predicted third portion of the data included in the document corresponding to the item identifier associated with the item purchased by the customer, etc. The data extraction prediction may be generated using a prediction model and the document via other and/or additional methods without departing from embodiments disclosed herein.

In Step 206, the data extraction prediction is provided to a user. In one or more embodiments, the document data extractor may provide the document and the one or more data extraction predictions to the user validation manager. The user validation manager may generate a user interface (UI) that includes the document and the data extraction prediction or the multiple data extraction predictions.

In one or more embodiments, the UI may allow a user to visualize the document and the one or more data extraction predictions associated with the document. The UI may be interface that allows users to interface with a device through, for example, graphical icons and/or other types of sensory stimuli (e.g., sounds). For example, a UI may be a data structure that defines the information, arrangement, color, and/or other characteristics of portions of a display. The UI may also be interactive in that it enables users to provide input (e.g., input information via mouse clicks) with respect to different portions of the display.

The UI may include user interaction capabilities without departing from embodiments disclosed herein. For example, a user of the system may use an input device such as a mouse, keyboard, touch screen, etc., to interact with the elements of the UI. User interactions may include scrolling, selecting buttons or icons, entering information via a keyboard or touchscreen, and/or other user interactions without departing from embodiments disclosed herein. The UI may enable users to submit user validations that indicate whether data extraction predictions are correct and/or specify the correct portion of the data of the document are associated with each data type of the data extraction predictions.

While discussed above as including specific information, display configurations, and interaction capabilities, the UI may include other and/or additional information, display configurations, and/or interaction capabilities without departing from embodiments disclosed herein.

The user validation manager may provide the data extraction predication and the document to a user by displaying the UI to a user of the document preprocessing engine. The user validation manager may send the UI to another entity (e.g., a client, a third party entity, etc.) with the functionality to provide the UI to a user for user validation generation. The data extraction prediction may be provided to a user via other and/or additional methods without departing from embodiments disclosed herein.

In Step 208, user validation associated with the data extraction prediction is obtained. As discussed above, the UI may include user interaction capabilities. The user may use the UI user interaction capabilities (e.g., checking a box, clicking a button, entering in information via a keyboard or touching, highlighting a region of the document with a mouse, etc.) to generate one or more user validations associated with the data extraction prediction. A user validation may include information generated and submitted through the user interface that indicates whether the data extraction prediction is correct, and if it is incorrect, includes correction information. The correction information may specify the portion of the data included in the document and the location of the portion of the data within the document (e.g., horizontal and vertical coordinates of the region of the document that includes the portion of the data) that is actually associated with the data type associated with the data extraction prediction. The user validation information may obtain the user validation through the UI or from entities (e.g., clients, third party entities, etc.) providing the UI to the user. The user validation associated with the data extraction prediction may be obtained via other and/or additional methods without departing from embodiments disclosed herein.

In Step 210, a determination is made as to whether the user validation indicates that the data extraction prediction is correct. In one or more embodiments, the user validation manager may provide the user validation to the document data extractor. The document data extractor may then check the user validation to identify whether the user validation includes indications (e.g., flags, tags, and/or other indicators generated by the user through the UI) that the data extraction prediction is correct or incorrect. In one or more embodiments, if the user validation includes indications that the data extraction prediction is correct, then the document data extractor may determine that the user validation indicates that the data extraction prediction is correct. In one or more embodiments, if the user validation includes indications that the data extraction prediction is incorrect, then the document data extractor may determine that the user validation indicates that the data extraction prediction is incorrect. The determination as to whether the user validation indicates that the data extraction prediction is correct may be made via other and/or additional methods without departing from embodiments disclosed herein.

In one or more embodiments disclosed herein, if it is determined that the user validation indicates that the data extraction prediction is correct, then the method proceeds to Step 214. In one or more embodiments disclosed herein, if it is determined that the user validation indicates that the data extraction prediction is incorrect, then the method proceeds to Step 212.

In Step 212, an updated data extraction prediction is generated based on the user validation. In one or more embodiments, the document data extractor uses the correction information included in the user validation to generate an updated data extraction prediction. The updated data extraction prediction now includes the correct portion of the data included in the document associated with the corresponding data type. The updated data extraction prediction may be generated based on the user validation via other and/or additional methods without departing from embodiments disclosed herein.

In Step 214, data preparation is performed on a copy of the document based on the user validation and the data extraction prediction to generate a training document. In one or more embodiments, the document data extractor performs data preparation on the document. The data preparation may include generating a copy of the document and the data extraction prediction. The data preparation may further include including and/or otherwise associating the user validation and the copy of the data extraction prediction with the copy of the document to generate a corresponding training document. The data preparation may be performed on the copy of the document based on the user validation and the data extraction prediction to generate a training document via other and/or additional methods without departing from embodiments disclosed herein.

In Step 216, the training document, the user validation, and the data extraction prediction are stored in a document repository. In one or more embodiments, the document data extractor provides the training document that includes the document copy, the user validation, and the data extraction prediction to the document collection manager. The document collection manager may store the training document in the document repository of the storage of the document preprocessing engine. The training document, the user validation, and the data extraction prediction in the document repository via other and/or additional methods without departing from embodiments disclosed herein.

In Step 218, performance of additional document processing using the document based on the data extraction prediction is initiated. In one or more embodiments, the document data extractor may initiate the performance of additional document processing using the document based on the data extraction prediction by sending a message to the client associated with client identifier associated with the document. The message may include the document and the data extraction prediction. In response to obtaining the message, the client may perform additional document processing (e.g., purchase order processing, inventory management, etc.) using the document based on the data extraction prediction. Performance of the additional document processing using the document based on the data extraction prediction may be initiated via other and/or additional methods without departing from embodiments disclosed herein.

In one or more embodiments disclosed herein, the method ends following Step 218.

Turning now to FIG. 2B, FIG. 2B shows a flowchart of a method performed to update prediction models in accordance with one or more embodiments disclosed herein. The method shown in FIG. 2B may be performed, for example, by a combination of the document collection manager (e.g., 112 FIG. 1), the document data extractor (e.g., 114, FIG. 1), and the user validation manager (e.g., 116, FIG. 1). Other components of the system in FIG. 1 may perform all, or a portion, of the method of FIG. 2B without departing from the scope of the embodiments described herein.

While FIG. 2B is illustrated as a series of steps, any of the steps may be omitted, performed in a different order, additional steps may be included, and/or any or all of the steps may be performed in a parallel and/or partially overlapping manner without departing from the scope of the embodiments described herein.

Initially, in Step 220, a prediction model update event is identified. In one or more embodiments, the data extractor may identify the prediction model update event. The prediction model update event may include obtaining a prediction model update request from a user (e.g., a user of the document preprocessing engine, a user of a client, etc.), the occurrence of a point in time specified by a prediction model update schedule, or identifying a prediction model accuracy that is below a configurable accuracy threshold. The document data extractor may monitor a prediction model update schedule and identify points in time specified by the prediction model update schedule. The document data extractor may also periodically or continuously calculate the prediction model accuracy (e.g., the percentage of the data extraction predictions generated during a configurable time period or for a configurable amount of data extraction predictions that are correct) for a configurable time period and/or for a configurable amount of data extraction predictions. The document data extractor may track the total number of data extraction prediction generated by the prediction model and the number of incorrect data extraction predictions generated by the prediction model. The document data extractor may compare the calculated prediction model accuracy with the configurable accuracy threshold. The prediction model update event may be identified via other and/or additional methods without departing from embodiments disclosed herein.

In Step 222, training documents included in the document repository are obtained. In one or more embodiments, the document data extractor obtains, via the document collection manager, the training documents from the document repository. In one or more embodiments, the document data extractor may obtain all, or a portion, of the training documents included in the document repository without departing from embodiments disclosed herein. For example, the document data extractor may obtain training document generated after a point in time using the training document creation timestamps. The training documents included in the document repository may be obtained via other and/or additional methods without departing from embodiments disclosed herein.

In Step 224, data preparation is performed on the training documents to generate updated training documents. In one or more embodiments disclosed herein, the document data extractor may perform data preparation on the training documents by generating spatial features and textual features corresponding to the data extraction predictions of the documents. The spatial features may specify a region of the documents the portions of the data of the data extraction predictions are located. The spatial features may include, for example, horizontal and vertical coordinates corresponding to a rectangular region of the document that includes the portion of the data of the data extraction prediction. The textual features may include the text of the portion of the data associated with the data extraction prediction. The textual and spatial features may be included in, or otherwise associated with, each training document to generate updated training documents. Other and/or additional features associated with the training documents may be generated and included in, or otherwise associated with, the training documents without departing from embodiments disclosed herein. Data preparation may be performed on the training documents to generate updated training documents via other and/or additional methods without departing from embodiments disclosed herein.

In Step 226, an updated prediction model is generated using the updated training documents. In one or more embodiments, the document data extractor may apply the updated training documents to a deep learning prediction algorithm to generate the updated prediction model. The updated prediction model may be a deep learning prediction model. As discussed above, the deep learning prediction algorithm may be any type of deep learning algorithm for generating deep learning models (e.g., deep neural networks, deep reinforcement learning networks, convolutional neural networks, etc.) without departing from embodiments disclosed herein. The updated prediction model may be generated using the updated training documents via other and/or additional methods without departing from embodiments disclosed herein.

In Step 228, the previous prediction model is replaced with the updated prediction model. In one or more embodiments, the document data extractor may store the updated prediction model in the prediction model repository. The document data extractor may denote that the update prediction model is the most recently generated prediction model by, for example, setting a flag associated with updated prediction model, generating a creation timestamp associated with the updated prediction model, etc. As a result, the document data extractor may use the updated prediction model to perform document data extraction services moving forward. The previous prediction model may be replaced with the updated prediction model via other and/or additional methods without departing from embodiments disclosed herein.

In one or more embodiments disclosed herein, the method ends following Step 228.

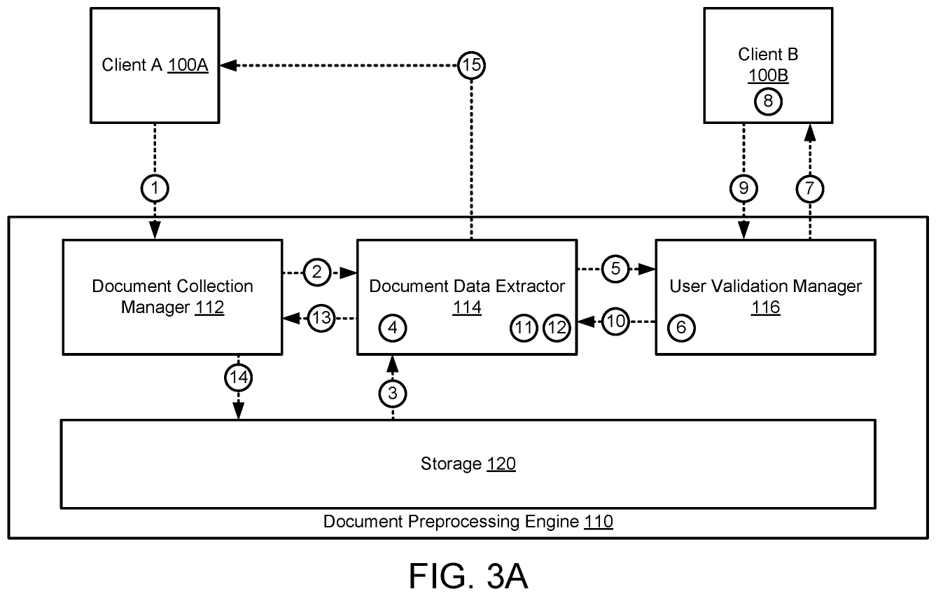

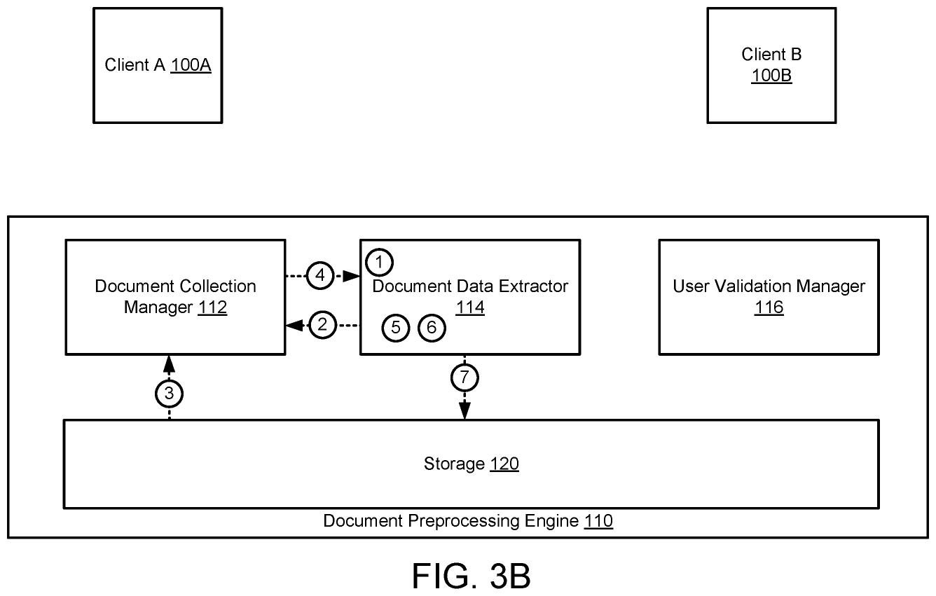

To further clarify aspects of embodiments disclosed herein, non-limiting examples are provided in FIGS. 3A-3B. FIGS. 3A-3B show diagrams of an example system and actions that may be performed by the example systems over time. The example systems of FIGS. 3A-3B may be similar to that of FIG. 1. For the sake of brevity, only a limited number of components of the system of FIG. 1 are illustrated in FIGS. 3A-3B.

### Examples

Starting with FIG. 3A, FIG. 3A shows a diagram of a first example in accordance with one or more embodiments disclosed herein. The first example may include generating a data extraction prediction for a document prior to further processing by a client.

Consider a scenario as illustrated in FIG. 3A in which a data preprocessing engine (110) is providing document data extraction services for client A (100A). Client A (100A) performs purchase order processing services. Client B (100B) is used by a system administrator providing user validations for data extraction predictions generated by the document preprocessing engine (110). To perform the document data extraction services, the document preprocessing engine includes a document collection manager (112), a document data extractor (114), a user validation manager (116), and storage (120).

At a first point in time, client A (100A) sends a document data extraction request to the document collection manager (112) [1]. The document data extraction request includes a document on which document data extraction services will be performed. The document is a purchase order. The document collection manager (112) then provides the document to the document data extractor (114) [2]. After obtaining the document, the document data extractor (114) then obtains the most recently generated prediction model from storage (120) [3]. Next, the document data extractor (114) then uses the most recently generated prediction model and the document to generate a data extraction prediction for the shipping address included in the document [4]. The data extraction prediction includes a portion of the data of the document predicted to be the shipping address and a region of the document that the portion of the data is located.

The document data extractor (114) then provides the document and the data extraction prediction to the user validation manager (116) [5]. In response to obtaining the document and the data extraction prediction, the user validation manager (116) generates a user interface that specifies the document and the data extraction prediction [6]. The user validation manager (116) then provides the user interface to client B (100B) [7]. Client B (100B) then provides the user interface to the system administrator performing user validation. The system administrator, through client B (100B) and the user interface, then generates a user validation associated with the document and the data extraction prediction [8]. The user validation indicates that the original data extraction prediction is incorrect. The original data extraction prediction includes a customer headquarters address which is different than the shipping address. The user validation includes the shipping address and a region of the document in which the shipping address is located.

Client B (100B) then sends the user validation to the user validation manager (116) [9]. The user validation manager (116) then provides the user validation, the document and the data extraction prediction to the document data extractor (114) [10]. After obtaining the user validation, the document, and the data extraction prediction, the document data extractor (114) determines that the user validation indicates that the data extraction prediction is incorrect [11]. In response to the determination, the document data extractor (114) generates an updated data extraction prediction using the user validation to include the correct portion of the data corresponding to the shipping address and the correct region of the document that includes the portion of data [12].

The document data extractor (114) then generates a copy of the document and the updated data extraction prediction, and includes the updated data extraction prediction and the user validation in the copy of the document to generate a training document. The document data extractor (114) then sends the training document to the document collection manager (112) [13]. The document collection manager (112) then stores the training document in the storage (120) for future prediction model updates [14]. Finally, the document data extractor (114) sends a message to client A (100A) initiate further purchase order processing using the document and the updated data extraction prediction [15]. The message includes the document and the data extraction prediction.

Turning to FIG. 3B, FIG. 3B shows a diagram of a second example in accordance with one or more embodiments disclosed herein. The second example may include updating a prediction model and replacing the previous prediction model with the updated prediction model.

Consider a scenario as illustrated in FIG. 3B in which a data preprocessing engine (110) is providing document data extraction services for client A (100A). Client A (100A) performs purchase order processing services. Client B (100B) is used by a system administrator providing user validations for data extraction predictions generated by the document preprocessing engine (110). To perform the document data extraction services, the document preprocessing engine includes a document collection manager (112), a document data extractor (114), a user validation manager (116), and storage (120).

At a first point in time, the document data extractor (114) calculates the prediction model accuracy for the last one thousand data extraction prediction. The prediction model accuracy for the last one thousand data extraction predictions is 87 percent. The configurable accuracy threshold is set to 90 percent. The document data extractor (114) may compare the calculated prediction model accuracy with the configurable accuracy threshold and determine that the prediction model accuracy is below the configurable accuracy threshold. Therefore, the document data extractor (114) identifies a prediction model update event [1].

In response to identifying the prediction model update event, the document data extractor (114) sends a request for training documents to the document collection manager (112) [2]. In response to obtaining the request, the document collection manager (112) retrieves the training documents from the storage (120) [3]. The document collection manager (112) then provides the training documents to the document data extractor (114) [4]. The document data extractor (114) then performs data preparation to generate spatial and textual features associated with each data extraction prediction for each training document to obtain updated training documents [5].

After obtaining the updated training documents, the document data extractor (114) applies a deep learning neural network algorithm to generate an updated prediction model [6]. The updated prediction model includes a deep learning neural network. The document data extractor (114) then replaces the previously generated prediction model with the updated prediction model and stores the updated prediction model in the storage (120) [7]. As a result, the updated prediction model will be used by the document data extractor (114) to generate future data extraction predictions.

End of Examples

Embodiments disclosed herein may be implemented using computing devices and/or computing systems. FIG. 4 shows a diagram of a computing device in accordance with one or more embodiments disclosed herein. Computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), communication interface (412) (e.g., Bluetooth interface, infrared interface, network interface, optical interface, etc.), input devices (410), output devices (408), and numerous other elements (not shown) and functionalities. Each of these components is described below.

In one embodiment disclosed herein, computer processor(s) (402) may be an integrated circuit for processing instructions. For example, the computer processor(s) may be one or more cores or micro-cores of a processor. Computing system (400) may also include one or more input devices (410), such as a touchscreen, keyboard, mouse, microphone, touchpad, electronic pen, or any other type of input device. Further, communication interface (412) may include an integrated circuit for connecting computing system (400) to a network (not shown) (e.g., a local area network (LAN), a wide area network (WAN) such as the Internet, mobile network, or any other type of network) and/or to another device, such as another computing system.

In one embodiment disclosed herein, computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to computer processor(s) (402), non-persistent storage (404), and persistent storage (406). Many different types of computing devices exist, and the aforementioned input and output device(s) may take other forms.

In one or more embodiments, any non-volatile storage (not shown) and/or memory (not shown) of a computing device or system of computing devices may be considered, in whole or in part, as non-transitory computer readable mediums, which may store software and/or firmware.

Such software and/or firmware may include instructions which, when executed by the one or more processors or other hardware (e.g., circuitry) of a computing device and/or system of computing devices, cause the one or more processors and/or other hardware components to perform operations in accordance with one or more embodiments described herein.

The software instructions may be in the form of computer readable program code to perform, when executed, methods of embodiments as described herein, and may, as an example, be stored, in whole or in part, temporarily or permanently, on a non-transitory computer readable medium such as a compact disc (CD), digital versatile disc (DVD), storage device, diskette, tape storage, flash storage, physical memory, or any other non-transitory computer readable medium. As discussed above, embodiments disclosed herein may be implemented using computing devices.

The problems discussed throughout this disclosure should be understood as being examples of problems solved by embodiments disclosed herein and the embodiments disclosed herein should not be limited to solving the same/similar problems. The disclosed embodiments are broadly applicable to address a range of problems beyond those discussed herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for performing data extraction for documents, comprising:
obtaining a data extraction request associated with a document;
in response to obtaining the request:
generating a data extraction prediction using a prediction model and the document;
providing the data extraction prediction to a user;
obtaining a user validation associated with the data extraction prediction;
making a determination that the user validation indicates that the data extraction prediction is not correct;
in response to the determination:
generating an updated data extraction prediction based on the user validation; and
initiating performance of additional document processing using the document based on the updated data extraction prediction.

2. The method of claim 1, wherein providing the data extraction prediction to the user comprises:
generating a user interface that specifies the document and the data extraction prediction; and
providing the user interface to the user.

3. The method of claim 2, wherein obtaining the user validation associated with the data extraction prediction comprises obtaining user indications specifying the user validation through the user interface.

4. The method of claim 1, wherein performing the data preparation on the copy of the document based on the user validation and the updated data extraction prediction to generate the training document comprises:
generating a spatial feature associated with the updated data extraction prediction; and
generating a textual feature associated with the updated data extraction prediction.

5. The method of claim 1, further comprising:
prior to initiating performance of additional document processing using the document based on the updated data extraction prediction:
performing data preparation on a copy of the document based on the user validation and the updated data extraction prediction to generate a training document; and
storing the training document, the user validation, and the data extraction prediction in a document repository, wherein the document repository comprises:
a plurality of previously generated training documents,
a plurality of previously generated data extraction predictions, and
a plurality of previously obtained user validations.

6. The method of claim 5, further comprising:
after initiating the performance of the additional document processing using the document based on the updated data extraction prediction:
identifying a prediction model update event;
obtaining training documents from the document repository;
performing data preparation on the training documents to generate updated training documents, wherein the updated training documents comprise:
the plurality of previously generated training documents,
the plurality of previously generated data extraction predictions, and
the plurality of previously obtained user validations;
generating an updated prediction model using the updated training documents; and
replacing the prediction model with the updated prediction model.

7. The method of claim 6, wherein the prediction model update event comprises determining that a prediction accuracy associated with the prediction model is below an accuracy threshold.

8. A non-transitory computer readable medium comprising computer readable program code, which when executed by a computer processor enables the computer processor to perform a method for performing data extraction for documents, the method comprising:
obtaining a data extraction request associated with a document;
in response to obtaining the request:
generating a data extraction prediction using a prediction model and the document;
providing the data extraction prediction to a user;
obtaining a user validation associated with the data extraction prediction;
making a determination that the user validation indicates that the data extraction prediction is not correct;
in response to the determination:
generating an updated data extraction prediction based on the user validation; and
initiating performance of additional document processing using the document based on the updated data extraction prediction.

9. The non-transitory computer readable medium of claim 8, wherein providing the data extraction prediction to the user comprises:
generating a user interface that specifies the document and the data extraction prediction; and
providing the user interface to the user.

10. The non-transitory computer readable medium of claim 9, wherein obtaining the user validation associated with the data extraction prediction comprises obtaining user indications specifying the user validation through the user interface.

11. The non-transitory computer readable medium of claim 8, wherein performing the data preparation on the copy of the document based on the user validation and the updated data extraction prediction to generate the training document comprises:
generating a spatial feature associated with the updated data extraction prediction; and
generating a textual feature associated with the updated data extraction prediction.

12. The non-transitory computer readable medium of claim 8, further comprising:
prior to initiating performance of additional document processing using the document based on the updated data extraction prediction:
performing data preparation on a copy of the document based on the user validation and the updated data extraction prediction to generate a training document; and
storing the training document, the user validation, and the data extraction prediction in a document repository, wherein the document repository comprises:
a plurality of previously generated training documents,
a plurality of previously generated data extraction predictions, and
a plurality of previously obtained user validations.

13. The non-transitory computer readable medium of claim 12, further comprising:
after initiating the performance of the additional document processing using the document based on the updated data extraction prediction:
identifying a prediction model update event;
obtaining training documents from the document repository;
performing data preparation on the training documents to generate updated training documents, wherein the updated training documents comprise:
the plurality of previously generated training documents,
the plurality of previously generated data extraction predictions, and
the plurality of previously obtained user validations;
generating an updated prediction model using the updated training documents; and
replacing the prediction model with the updated prediction model.

14. The non-transitory computer readable medium of claim 13, wherein the prediction model update event comprises determining that a prediction accuracy associated with the prediction model is below an accuracy threshold.

15. A system for performing data extraction for documents comprises:
a plurality of clients; and
a document preprocessing engine configured to:
obtain a data extraction request associated with a document from a client of the plurality of clients;
in response to obtaining the request:
generate a data extraction prediction using a prediction model and the document;
provide the data extraction prediction to a user;
obtain a user validation associated with the data extraction prediction;
make a determination that the user validation indicates that the data extraction prediction is not correct;
in response to the determination:
generate an updated data extraction prediction based on the user validation; and
initiate performance of additional document processing using the document based on the updated data extraction prediction.

16. The system of claim 15, wherein providing the data extraction prediction to the user comprises:
generating a user interface that specifies the document and the data extraction prediction; and
providing the user interface to the user.

17. The system of claim 16, wherein obtaining the user validation associated with the data extraction prediction comprises obtaining user indications specifying the user validation through the user interface.

18. The system of claim 15, wherein performing the data preparation on the copy of the document based on the user validation and the updated data extraction prediction to generate the training document comprises:
generating a spatial feature associated with the updated data extraction prediction; and
generating a textual feature associated with the updated data extraction prediction.

19. The system of claim 15, wherein the document preprocessing engine is further configured to:
prior to initiating performance of additional document processing using the document based on the updated data extraction prediction:
perform data preparation on a copy of the document based on the user validation and the updated data extraction prediction to generate a training document; and
store the training document, the user validation, and the data extraction prediction in a document repository, wherein the document repository comprises:
a plurality of previously generated training documents,
a plurality of previously generated data extraction predictions, and
a plurality of previously obtained user validations.

20. The system of claim 19, wherein the document preprocessing engine is further configured to:
after initiating the performance of the additional document processing using the document based on the updated data extraction prediction:
identify a prediction model update event;
obtain training documents from the document repository;
perform data preparation on the training documents to generate updated training documents, wherein the updated training documents comprise:
the plurality of previously generated training documents,
the plurality of previously generated data extraction predictions, and
the plurality of previously obtained user validations;
generate an updated prediction model using the updated training documents; and
replace the prediction model with the updated prediction model.
